(19) United States
(12) Patent Application Publication
(10) Pub. No.: US 2009/0316692 A1
(43) Pub. Date: Dec. 24, 2009

(54) UNIFIED RECEPTION AND PROCESSING OF MULTI-PROTOCOL COMMUNICATION SERVICES

(75) Inventors: Thorsten Trapp, Hagen (DE); Ralph Eric Kunz, Wiesbaden (DE)

Correspondence Address: INTELLECTUAL PROPERTY / TECHNOLOGY LAW, PO BOX 14329, RESEARCH TRIANGLE PARK, NC, 27709, US

(73) Assignee: TYNTEC LTD.

(21) Appl. No.: 12/550,172

(22) Filed: Aug. 28, 2009

Related U.S. Application Data
(63) Continuation-in-part of application No. PCT/EP08/03283, filed on Apr. 23, 2008.

(30) Foreign Application Priority Data
Apr. 23, 2007 (GB) 0707791.0

(51) Int. Cl. H04L 12/66; H04W 40/00

(52) U.S. Cl. 370/352; 455/445; 455/466; 709/206

(57) ABSTRACT

A method and an apparatus and server for the receipt of a message addressed to a single identifier for forwarding to a customer is described in which the message uses one of a plurality of message formats, The method comprises receiving the message at a receiving one of a plurality of receivers in one or more of a plurality of telecommunications networks in accordance with the one of the plurality of message formats, wherein the message uses one of a plurality of message formats, the one of the plurality of message formats being independent of the single identifier, passing the message from the receiving one of the plurality of receivers to a central platform and forwarding the message from the central platform to the customer, wherein the single identifier is chosen from a plurality of identifiers provided to the central platform by the one or more telecommunications networks, the single identifier being assigned to the customer. The apparatus comprises a plurality of receivers for receiving the message, a central platform connected to the plurality of receivers, and a connection to the customer for forwarding the message from the central platform to the customer. The central platform comprises a central server and a central database server comprises a database for managing the identifiers.

### CROSS-REFERENCE TO RELATED APPLICATION

This application is a continuation-in-part of international patent application PCT/EP2008/003283 filed on 23 Apr. 2008 which claims the benefit and priority of UK Patent Application GB 0707791.0 filed on 23 Apr. 2007.

### FIELD OF THE INVENTION

The field of invention relates to a method and apparatus for the transmission of a multi-protocol message to an application. In particular, the invention relates a method and apparatus for the receipt of a message using one of a plurality of message formats with a unique identifier.

### BACKGROUND OF THE INVENTION

Mobile telecommunications networks have become increasingly ubiquitous. These allow a user to use a mobile station—such as a mobile telephone or a PDA—to communicate with others on the same mobile telecommunications network, on other mobile telecommunications networks or on fixed line networks. Increasingly the mobile telecommunications networks are being used to transfer data and instant messaging (IM) as well as voice.

Initially, the data transfer was carried out using SMS messages. The SMS messages were designed to transmit a small amount of data such as short unformatted text messages over the network of a single mobile telecommunications networks operator. Each one of the mobile stations within the mobile telecommunications network is assigned a home Short Message Service Centre (SMS-C) which handles the SMS messaging for that mobiles station or user. As is known in the art, the SMS message is sent to the home SMS-C of the user originating the message. In order to route the SMS message to the intended recipient, a request for routing information is normally sent by the SMS-C to a Home Location Register (HLR) which contains information for the mobile station to which the SMS message is to be sent. The HLR supplies the required routing information to the SMS-C which then transmits the SMS message to the Visitor Location Register (VLR)/Mobile Switching Centre (MSC) to which the intended recipient is connected. This procedure is described in the ETSI TS 100 974.

The SMS message can also be sent to applications, such as computer application or databases. For example UK Patent Application No 2415577 (Yoomedia PLC) teaches an SMS-C which is provided with an application interface. The application is assigned, according to the teachings of this patent application, with what is known as a “short number” comprising a reduced number of digits compared to a usual format for the mobile numbers. In the example taught in the application the SMS-C was programmed to recognise the short numbers when they are received in the header of an SMS message so that the message is forwarded to the application interface rather than being routed across the mobile telecommunications network.

Initially the application interfaces were intended to host proprietary applications for the networks of the network operators. The success of SMS messaging has meant that network operators now allow either an application from third parties to be directly connected to the application interfaces or for connections between the SMS-C and the Internet (or a proprietary network).

In more recent developments, more than one network operator has adopted the same short code for the same application so that it becomes immaterial to which mobile telecommunications network the mobile station sending the SMS message is connected. In Germany, for example, common short numbers have been adopted by all of the four major mobile telecommunications networks to allow, for example, voting in television programmes. The mobile station connected to any of the four major mobile telecommunications networks can send an SMS message to the SMS-C responsible for the major mobile telecommunications network using the common short number. Each of the SMS-Cs will intercept the SMS message, recognise that is to be passed to a specified application via an application interface and will pass the SMS message to the application.

European Patent Application No. EP 1 662 812 (Empower Interactive Group Ltd.) teaches a method for routing SMS messages to an application through a plurality of message delivery points in the same mobile telecommunications network. This has the advantage that the routing of the SMS messages can be changed to ensure that the load on the mobile telecommunications network is balanced.

The teachings of the above patent applications rely on the use of a special common short number to identify those SMS messages which need to be “removed” from the usual message delivery service and treated in a different manner by forwarding them to an application. There is, however, a major restriction on the use of the common short numbers—their number is limited. In particular attempts to establish “international” common short numbers have foundered either on the unwillingness of some network operators to collaborate through fear of losing business (or lacking the appropriate software) or by the fact that the proposed numbers have been previously occupied.

In addition to SMS messages, mobile telecommunications networks nowadays carry data using several other protocols, for example MMS which uses an IP protocol. To use short codes also for this MMS service a special handling procedure is needed—similar to enabling SMS reception on short codes as mentioned above. In this case, it is in the MMSC of the mobile telecommunications network operator. To take one example, sending an MMS to a common short number designed for the receipt of a SMS message will—unless special software has been installed—lead to an error message or simply “get lost” as a receiver receiving the messages sent by the MMS protocol will generally not have been programmed with the common short number. There is therefore a need to develop a system which can take and receive messages in a variety of formats without the need to worry about which number is accessed.

The European patent application EP 1 601 146 (France Telecom) discloses a system for forwarding an email message to a recipient. The recipient is identified by its telephone number. The system includes the step of identifying the email address of the recipient associated with the telephone number.

The U.S. Pat. No. 6,625,258 (Nortel Networks Ltd.) describes a virtual assistant system. A profile services uniquely identifies each subscriber and provides contact information for the subscriber.

The France Telecom patent application and the Nortel Networks patent both teach systems for uniquely identifying a subscriber.

The international patent application WO 03/021900 (R. Agarwal et al.) teaches a system and a method which enable a first user to communicate in multiple telecommunications formats with a second user identified by a single user identifier, such as a telephone number or conventional e-mail address. A provider associated with the unified messaging server (UMS) identifies the format and can change the format. The provider transmits the message as a real time connection or as a non-real time connection. To allow the exchange of messages also between more than one of the above mentioned UMS, the UMS must be directly connected with each other. The UMS defined in this patent application does not have the capability of being invoked from a different network which does not have a UMS server or does not have a UMS interconnection.

The UMS systems of the Agarwal patent application have the capability to handle messages using different type of formats, identify the format, and forward the message to the recipient in either the same format or another format.

The US patent application US 2006/0025164 (Wang) also describes a Unified Message Service. In the system of the Wang patent, calls/messages are sent to a unified message service system node. The unified message service system node in turn forwards the call to a fixed/mobile phone, may send a fax, and may send SMS/instant messages to the intended recipient.

Another example of such Unified Message Service system is also disclosed in the German patent publication DE 101 21 705 (Web.DE AG).

The UMS systems of the prior art have different receivers capable of handling messages received in SMS and voice formats. The Agarwal, Wang or Web.DE patent applications disclose a centralized management of all incoming messages, using a single identifier for the incoming messages. In these prior art systems, the user needs to have subscribed to such a system, and all messages sent by the user are first received at a messaging server, which forwards the message to the intended recipient.

The applications accessed through the application interface can often only handle messages sent in a particular format. For example, an application connected to an SMS-C through the Internet will generally expect to see a message using the Internet Protocol.

Such attempts at the conversion of messages from one protocol to another are known in the past. A simple example is that which converts SMS messages sent to a fixed line number to voice messages. This is carried out by intercepting in the SMS-C any SMS message addressed to a fixed line number and passing this intercepted SMS message to a separate server. In the separate server the addressed fixed line number is first tested to see whether it has the capability to receive messages in an SMS format. If that is the case, then the SMS message is sent via the fixed line to the addressed telephone number. In the event, however, that the addressed fixed line number cannot accept the message in SMS format, the SMS message is converted to a voice message and the addressed fixed line number is rung and the intercepted message—as a voice message—is conveyed to a listener. This is disclosed in the article “BT trials mobile SMS to voice landline” by John Leyden published 8 Jan. 2004 in the Register (URL: http://www.theregister.co.uk/2004/01/08/bt_trials_mobile_sms/accessed on 29 Mar. 2006).

This solution to the delivery of SMS messages to the fixed line number is a useful tool. However, it cannot be generalised to the conversion of all types of protocols into other protocols.

US Patent Application US 2003/0104827 (Moran et al) discloses a method in which an SMS message is converted to an e-mail for transfer to another wireless access point. This is used to allow the delivery of SMS message to another wireless network in which there is no opportunity to exchange the SMS messages directly. It does not disclose, however, the passage of the SMS message in either SMS format or in e-mail format to an application.

There therefore remains a need for a system which can accept messages in any one of a multiple number of protocols and supply these to an application in the required protocol.

There is further a need for providing a universal number for the acceptance of messages in any one of a multiple number of protocols.

There is furthermore a need for allowing access to the same application using a number of different numbers.

There is further a need for providing a system which can be accessed by different networks (national or international).

### SUMMARY OF THE INVENTION

These and other objects of the invention are solved by providing a method for the receipt of a network communication item addressed to a single identifier for forwarding to a customer, wherein the network communication item uses one of a plurality of network telecommunications formats. The method comprises: —receiving the message at a receiving one of a plurality of receivers in one or more of a plurality of telecommunications networks, wherein the message uses one of a plurality of message formats, the one of the plurality of message formats being independent of the single identifier, wherein the message is received at different ones of the plurality of receivers in accordance with the one of the plurality of message formats,—passing the message from the receiving one of the plurality of receivers to a central platform, wherein the central platform is connected to more than one of the plurality of receivers; forwarding the message from the central platform to the customer, wherein the single identifier is chosen from a plurality of identifiers provided to the central platform by the one or more telecommunications networks, the single identifier being assigned to the customer.

The receivers are designed to receive communication which is not limited to but could be routed from other networks through the international telecommunications network to the receiver.

The message may be forwarded either in the one of the plurality of message formats or in another one of plurality of message formats.

The central platform may use an IP network protocol for forwarding the message.

The central platform may forward the message to a service provider which can handle the message.

The single identifier may be a MSISDN according to the ITU-T E.164 Standard or a NANP (North American Numbering Plan) Standard or any other numbering format routable in international telecommunications network.

The single identifier may define an application that is to be addressed by or connected with the network communication.

The network communication may be a voice call, such as a PSTN, 3G or GSM communication, a video call, especially but not limited to H.324m (3GPP) (see http://de.wikipedia.org/wiki/3g-h.334.m; accessed on 27 Aug. 2009), or a data communication in form of a message. The format may be selected from one of the formats consisting of PSTN Circuit switched Voice, SMS, MMS, VoIP, and Instant Messenger (e.g. XMPP as defined in RFC 3920) but is not limited thereto.

The method may further comprise terminating the protocol at one of the plurality of the receivers and passing the network communication from the terminating one of the plurality of the receivers to the central platform using a transport protocol. Thereby, transparent and non-transparent modes can be used and mixed.

An apparatus is also disclosed for the receipt of a message addressed to a single identifier for forwarding to a customer, wherein the message uses one of a plurality of message formats, comprising:—a plurality of receivers for receiving the message, different ones of the plurality of receivers being configured to receive the message in different ones of the plurality of message formats, at least two of the plurality of receivers being connected to different ones of a telecommunications network,—a central platform connected to the plurality of receivers, wherein the message is passed from the plurality of receivers to the central platform; and—a connection to the customer for forwarding the message from the central platform to the customer. The single identifier is chosen from a plurality of identifiers provided to the central platform by the one or more telecommunications networks, the single identifier being assigned to the customer,

The apparatus may be adapted to forward the message either in the one of the plurality of message formats or in another one of plurality of message formats.

The central platform may be adapted to forward the message using an IP network protocol.

A protocol terminator at least one of the plurality of receivers may be used to for terminating.

A network device may be provided for transmitting the network communication from the one of the plurality of receivers to the central platform using a transport protocol.

The connection to the customer for forwarding the message from the central platform to the customer may be adapted for handling a plurality of codecs.

The invention also proposes a system as a central platform comprising a central database and a central server.

The central database preferably comprises settings associated to the single identifier, the central platform being adapted to choose one of the plurality of codecs depending on the settings.

The system is adapted to handle connections using transport protocol

### DESCRIPTION OF THE FIGURES

FIG. 1 shows a customer edge of a telecommunications network according to the state of the art.

FIG. 2 shows a customer edge of a telecommunications network according to the invention.

FIG. 3 shows an embodiment of a central platform according to the invention

FIG. 4 shows a workflow for the receipt of a message using a single identifier according to the invention.

### DETAILED DESCRIPTION OF THE INVENTION

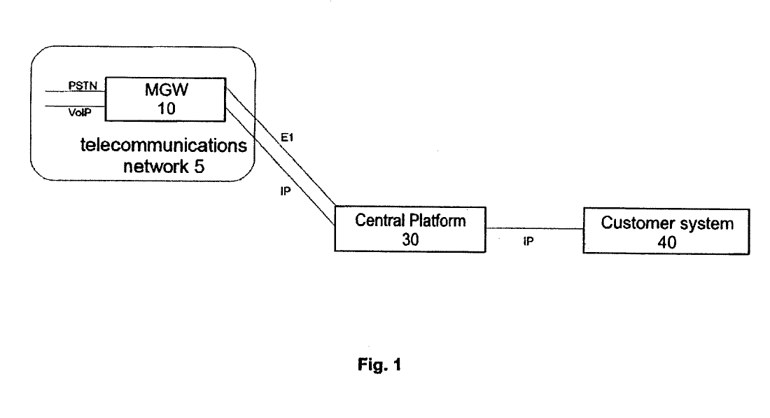

FIG. 1 shows a telecommunications network 5 as known in the art. The telecommunications network 5 is suitable for both voice and data transmission and can operate with a number of different protocols as will be explained below. The telecommunications network has a media gate way (MGW) 10 which receives communication items in the form of standard Public Switched Telephone Number (PSTN) telephone call or a voice over IP (VoIP) communication. In prior art systems, a PSTN identifier, such as a telephone number, may be used for addressing both the PSTN telephone call and the VoIP communication. Prior art systems may also employ a different identifier, such as an additional telephone number or a user name for a VoIP communication.

The communication item is terminated at the MGW 10 and redirected or further transmitted to a central platform 30 using another protocol. For example, an incoming PSTN telephone call is received at MGW 10 and redirected to the central platform using the IP protocol.

It should be noted that the MGW 10 can receive communications items using other protocols such as the H324m protocol which is used, for example, for 3G-Video calls.

The MGW 10 is typically installed at a location managed and run by an operator of a PSTN network or VoIP service. The central platform 30 is typically located at a site of a service provider which offers the unified access to cross network reception and processing of multi protocol communication services. The central platform 30 is connected to the MGW 10 through fixed telecommunication lines which may or may not be part of a PSTN network or the Internet. Dedicated telecommunications lines may also be used in the event that a high degree of security is required. The central platform 30 will direct the communication item received from the MGW 10 to, for example, a customer system 40. The customer system is a suitable telecommunications device which can process the communication item.

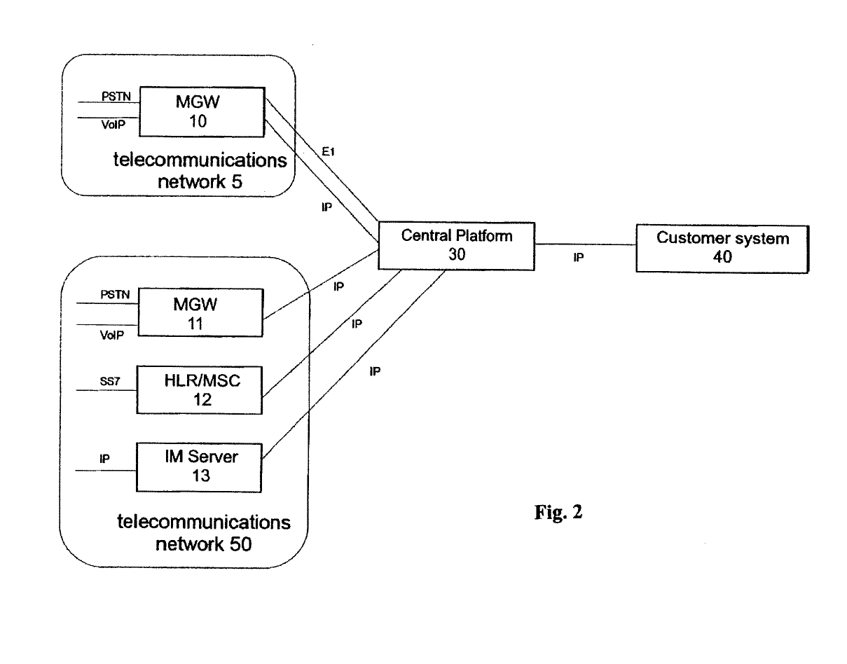

FIG. 2 shows the telecommunications networks 5 and 50 according to the invention. The telecommunications network 50 comprises in this aspect of the invention a second receiver 12 and a second MGW 11. The second receiver 12 will be, for example, a Home Location Register (HLR) and Visitor Location Register (VLR)/Mobile Switching Centre (MSC) for receiving communication items in yet a further format. In the example shown in FIG. 2 the second receiver 12 is connected to a mobile telecommunications network. This mobile telecommunications network 50 uses, for example, the SS7 protocol for the reception of SMS messages over the mobile telecommunications network 50. The SMS messages can not be handled by the second MGW 11.

The second receiver 12 receives the communication item via SS7 MAP and transfers the communication item via a transport protocol, for example IP, to the central platform 30 from where the communications item is further transferred to the customer system 40. The transfer of the communications item from the central platform 30 to the customer system 40 is carried out using, for example, the IP protocol.

The telecommunications network 50 shown in FIG. 2 also comprises in this aspect of the invention a third receiver 13 besides the MGW 11 and the HLR/MSC 12. The third receiver 13 will be, for example an instant messaging server for receiving communication items in a further format. In this example shown in FIG. 2 the third receiver 13 is connected to public internet and uses, for example, the XMPP protocol (as defined in RFC 3920) for the reception of instant messages. The instant messages can not be handled by the second MGW 11 or the HLR/MSC 12.

The third receiver 13 receives the communication item via IP and transfers the communication item via a transport protocol, for example IP, to the central platform 30 from where the communications item is further transferred to the customer system 40. The transfer of the communications item from the central platform 30 to the customer system 40 is carried out using, for example, the IP protocol.

Each of the communication items received by either the first MGW 10 or the second MGW 11 or the second receiver 12 uses a single identifier for identifying the customer system 40 to be reached. For the third receiver 13 the single identifier must be expanded by ‘@server.name’ in the XMPP example (where “server.name” is a place holder for the real domain name of the XMPP server). The single identifier may be a MSISDN number (as defined by the ITU-T E164 standard) or a number assigned under the North American Numbering Plan (NANP) of the customer or any other numbering format routable in international telecommunications network. This is advantageous as it means that the customer needs to only provide a single number to its potential customers for communications purposes. So, for example, a company advertising its products can give a single hotline number reachable by all forms of telecommunications. A consumer can chose to dial the number from his or her mobile telephone and the call will be received and terminated at the second receiver 12, converted to a first type of transport protocol and passed to the central platform 30 from which the call is passed to the customer system 40 (possibly via a second type of transport protocol). The consumer could also send a text message to the second receiver 12 where the text message is terminated according to ETSI TS 100 974 and transferred via the first type of transport protocol to the central platform 30 and then to the customer system 40. If the consumer uses a telecommunication device connected to the PSTN, then the call is received and terminated at the first MGW 10 and the second MGW 11 and transmitted via a third type of transport protocol (which could be the same as the first type of transport protocol) to the central platform 30 and thence to the customer system 40.

Another type of use case would be voting in a television programme. Currently it is necessary to allocate different telephone numbers for voice calls and SMS messages. Using the invention a single number could be allocated. Viewers of the television programme could chose to vote, for example for candidate one, by either texting the message to a number of the format 07624 80070-1 (or alternatively 0044 7624 80070-1 if an international dialling code is introduced) or dialling exactly the same number. If the dialled number was made over the PSTN then the communications item is received at the MGW 11, passed to the central platform 30 and then to the customer system 40. The customer system 40 will have a counter counting the number of communications items received in total. It should be noted that in this case the communication item is not a voice message but a message indicating a vote for candidate 1 even though the communications item is initially transmitted over the PSTN. If the viewer using a mobile telephone to dial the number 07624-80070-1 then the communications item will be carried over the international telecommunications network to the first receiver 11 where the communications item is received and terminated and passed from the first receiver 11 to the central platform 30 and finally to the customer system 40 where the vote is recorded at the counter. Similarly an SMS message could be sent to exactly the same number and will be received at the second receiver 12 before being passed to the central platform 30 and the customer system 40 and counted. The counter at the customer system 40 records all of the communications items received at the MGW 11 and/or the second receiver 12 and counts the communications items as votes for the candidate one. This scenario is not limited to the communication items initiated in the network 50 but also applicable for the communication items initiated in any one of the other telecommunications network having interconnection with the telecommunications network 50. Further the central platform 30 can have multiple connections to different ones of the network 50 or the network 5 and aggregates all telecommunications items passed through via a receiver to the attached customer systems 40. The exchange format is determined by the suitable protocol for each communication and on a mutual agreement on the customer and its provider for the unified access to the cross network reception and processing of multi protocol communication services.

It is important to note that communications items sent in different formats may be received by different ones of the receivers (i.e. the MGW 11 or the second receiver 12). The transfer to the central platform 30 can be made using the same format but is more likely to be made in a common format (e.g. carried via the IP format). Some of the receivers may be able to accept multiple protocols. Other ones of the receivers will only accept a single type of protocol. The MGW 11 and the second receiver 12 are shown in FIG. 2 as being separate units. However, there is nothing to stop them being incorporated on the same computer server.

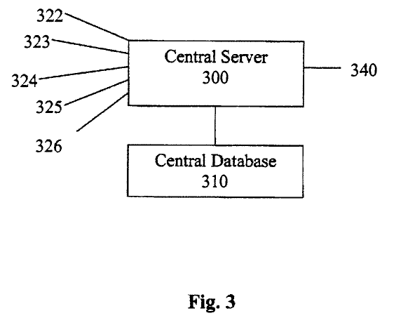

There are different outputs from the operator to a central platform 30, as shown in FIG. 3. A first output (SMS output) is for SMS messages. A second output (fax/voice output) is for voice/fax messages. A fax switch is connected to the voice/fax messages to separate voice messages and faxes. There could also be further units connected to the output from the operator. Examples of such further units include units for handling 3G calls or video calls.

FIG. 3 shows the central platform 30 according to one aspect of the disclosure.

The central platform 30 includes a central server 300 and a central database 310 connected to the central server 300. The central server 300 has connections 322 and 323 to the receiver 10 of the telecommunications network 5 and connections 324, 325 and 326 to the receivers 11, 12, 13 of the telecommunications network 50. The central server 300 has also a connection 340 to the customer system 40.

The central server 300 manages the plurality of identifiers provided by the telecommunication networks 5, 50. A unique single identifier is assigned to a customer and is chosen from the plurality of identifiers. The telecommunications networks 5, 50 may be located in different countries and the identifiers provided by the telecommunications networks 5, 50 may include numbers comprising country code.

The identifiers are preferably a MSISDN identifiers according to the ITU-T E.164 or NANP Standard. The identifier could be of any other numbering format routable in international telecommunications network.

The identifiers are stored in the central database 310 along with other features and reach lists.

The central database 310 also stores settings associated with the identifiers or with the different telecommunications networks 5, 50 or operators.

The central server 300 can chose an appropriate codec to use depending on the settings stored in the central database 310. The appropriate codec to be used may be chosen on a number of factors including call quality and bandwidth capacity. Non-limiting examples the appropriate codecs include a G7-11 codec or a G7-29B codec.

Although the system of this disclosure has been described with respect to two telecommunication networks 5, 50, the present system is not limited to two telecommunication networks 5, 50 and a plurality of the telecommunication networks 5, 50 can be connected to the central platform 300. It will be understood that the telecommunication networks 5, 50 connected to the central platform 300 may be from different countries and of different types. The central platform 300 is adapted to operate over multiple operators and countries.

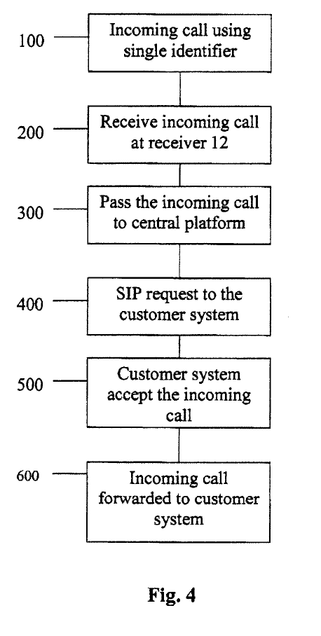

A method for the receipt of the message addressed to a single identifier for forwarding to the customer is described with reference to FIG. 4.

The user wishing to contact the customer may use the single identifier assigned to the customer. The single identifier is preferably a MSISDN according to the ITU-T E.164 or NANP Standard.

The message can be sent using a plurality of message formats, including SMS, MMS, Voice Call, Video Call, VoIP or Instant Messenger.

The SMS message formats use a signalling protocol. The Voice/Fax/Video message formats use a TDM protocol. The MMS message formats use IP signalling.

In this aspect, the user wishes to call the customer, at step 100. The message is received at the second receiver 12 of the telecommunication networks 50. The second receiver 12 is the one receiver of the telecommunication networks 50 that is adapted to receive the communication item in the call format (step 200).

The second receiver 12 first accepts an incoming call/message request as Initial Address Message (IAM) which includes the destination message number. The second receiver 12 identifies this destination message number as the single identifier number for the customer. The second receiver passes 12 the message to the central platform 30, at step 300.

The central server 300 of the central platform 30 converts the incoming call request in the form of SS7-IAM as a session initiation protocol (SIP) request (using the RFC 3398 standard—see http://tools.ietf.org/html/rfc3398; accessed on 27 Aug. 2009) to the customer system 40 (including destination number and, if known, caller number), at step 400.

The customer system 40 accepts the SIP-Request and decides whether to accept the incoming call request to the destination number or not. The customer system 40 answers the central server 300 via a further SIP message. This further SIP message may be either busy, hang up or accept call. If the incoming call is to be accepted the further SIP message includes any settings for handling the incoming call. These settings may include the appropriate codec for handling the incoming call. For example, the customer system 40 may have established that the codec using least bandwidth be used. The use of this codec would reduce cost associated with handling the incoming call, but at expense of call quality. On the other hand, the codec providing best call quality can be specified which would increase the amount of the bandwidth required for handling the incoming call.

If the customer system 40 accepts the message, the central server 300 passes an acceptance to the second receiver 12 which then accepts the incoming call, encodes the incoming call with the appropriate code and passes the encoded incoming call message is passed to the customer system 40 where the incoming call is handled (step 600).

There are a number of different manners in which the customer system 40 could handle the incoming call. SMS could be displayed in mail system. Voice call could ring on computer. The incoming call (in this case a voice call) could be passed directly to a regular telephone, a mobile telephone or a computer. The incoming call could be stored as WAV file and sent to a mail system or the incoming call could be passed to a voice box (as governed by RFC 3666). If the incoming message were not the voice call, but the SMS message, then the SMS message could be sent to a regular email system or passed to a mobile telephone for display to the user. Similarly if the incoming message were a fax message, then the incoming message could be passed the email system as an email or PDF fax or even using text-to-speech technology passed to the telephone of the user. It will be appreciated that other combinations of handling the incoming message by the customer system 40 are possible.

In the specific aspect discussed above, the incoming message is forwarded to the customer system 40, the connection using an IP protocol. The SMS messages may be transferred using SMPP/SIP protocol. The voice messages may be transferred using VoIP protocol. The fax messages may be transferred using TDM protocol, and the video calls using a combination of VoIP and Video over IP protocols.

It will be noted that the incoming message may be forwarded to the customer either in the same format as the format used by the caller or in another format. The customer may have indicated preferences for receiving message in preferred communication format. In other words, the apparatus may act as a transcoder which may transcode one communication protocol into another communication protocol.

It will be understood from the above description that the service provider can have access to multiple operators in multiple countries. This allows choice of the communication networks which may be used. The choice can be made on economic (e.g. cost), accessibility or quality criteria. The apparatus of the present disclosure can be understood as a multiple protocol receiver that manages a number of connected systems and networks, centrally.

The above description of the illustrated embodiments of the invention is not intended to be exhaustive or to limit the invention to the precise forms disclosed. Whilst specific embodiments of, and examples for, the invention are described herein for illustrative purposes, various equivalent modifications are possible within the scope of the invention as those skilled in the relevant art will recognise. Accordingly it is not intended that the scope of the invention in any way be limited by the above description, but instead be determined entirely by reference to the claims.

1. A method for the receipt of a message addressed to a single identifier for forwarding to a customer, wherein the message uses one of a plurality of message formats, comprising:
receiving the message at a receiving one of a plurality of receivers in one or more of a plurality of telecommunications networks, wherein the message uses one of a plurality of message formats, the one of the plurality of message formats being independent of the single identifier, wherein the message is received at different ones of the plurality of receivers in accordance with the one of the plurality of message formats;
passing the message from the receiving one of the plurality of receivers to a central platform, wherein the central platform is connected to more than one of the plurality of receivers;
forwarding the message from the central platform to the customer,
wherein the single identifier is chosen from a plurality of identifiers provided to the central platform by the one or more telecommunications networks, the single identifier being assigned to the customer.

2. The method of claim 1, the message is forwarded either in the one of the plurality of message formats or in another one of plurality of message formats.

3. The method of claim 1, wherein the central platform uses an IP network protocol for forwarding the message.

4. The method of claim 2, wherein the central platform forwards the message to a service provider which handles the message.

5. The method of claim 4, wherein the handling of the message comprises at least one of accepting the message, refusing the message, and establishing settings for acceptance of the message.

6. The method of claim 1, wherein the single identifier is a MSISDN according to the ITU-T E.164 or NANP Standard or any other numbering format routable in international telecommunications network.

7. The method of claim 1, wherein the single identifier identifies an application.

8. The method of claim 1, wherein the message format is selected from one of the formats consisting of SMS, MMS, Voice Call, Video Call, VoIP or Instant Messenger.

9. The method of claim 1 further comprising:
terminating the protocol at one of the plurality of the receivers and passing the message from the terminating one of the plurality of the receivers to the central platform using a transport protocol

10. An apparatus for the receipt of a message addressed to a single identifier for forwarding to a customer, wherein the message uses one of a plurality of message formats, comprising:
a plurality of receivers for receiving the message, different ones of the plurality of receivers being configured to receive the message in different ones of the plurality of message formats, at least two of the plurality of receivers being connected to different ones of a telecommunications network,
a central platform connected to the plurality of receivers, wherein the message is passed from the plurality of receivers to the central platform; and
a connection to the customer for forwarding the message from the central platform to the customer,
wherein the single identifier is chosen from a plurality of identifiers provided to the central platform by the one or more telecommunications networks, the single identifier being assigned to the customer.

11. The apparatus of claim 10, wherein the apparatus is adapted to forward the message either in the one of the plurality of message formats or in another one of plurality of message formats

12. The apparatus of claim 10, wherein the central platform is adapted to forward the message using an IP network protocol

13. The apparatus of claim 10, wherein the single identifier is a MSISDN according to the ITU-T E.164 or NANP Standard or any other numbering format routable in international telecommunications network.

14. The apparatus of claim 10, further comprising a protocol terminator at least one of the plurality of receivers, wherein the protocol terminator terminates the protocol at the at least one of the plurality of receivers.

15. The apparatus of claim 10, further comprising a network device for transmitting the message from the one of the plurality of receivers to the central platform using a transport protocol.

16. The apparatus of claim 10, wherein the single identifier identifies the application to be run on receipt of the message.

17. The apparatus of claim 10, wherein the connection to the customer for forwarding the message from the central platform to the customer is adapted for handling a plurality of codecs.

18. The apparatus of claim 10, wherein at least one of the plurality of receivers is adapted to encode the message using one of a plurality of codecs.

19. The apparatus of claim 10, wherein the central platform comprises a central database and a central server.

20. The apparatus of claim 19, wherein the central database comprises settings associated to the single identifier, the central platform being adapted to specify one of the plurality of codecs depending on the settings.

21. A system for the receipt of a message addressed to a single identifier for forwarding to a customer, wherein the message uses one of a plurality of message formats, the central platform comprising
a central server adapted to be connected to a plurality of receivers for receiving the message, different ones of the plurality of receivers being configured to receive different ones of the messages in different ones of the plurality of message formats, at least two of the plurality of receivers being connected to different ones of a telecommunications network,
a connection to the customer for forwarding the message from the central platform to the customer,
a central database connected to the central server,
wherein the single identifier is chosen from a plurality of identifiers provided to the central platform by the one or more telecommunications networks, the single identifier being assigned to the customer.

22. The system of claim 21, wherein the central database comprises settings associated to the single identifier, the central platform being adapted to choose one of the plurality of codecs depending on the settings.

23. The system of claim 21, wherein the connection to the customer for forwarding the message from the central platform to the customer is adapted for handling a plurality of codecs.

24. The system of claim 21, wherein the system is adapted to handle connections using a transport protocol.
